(19) United States
(12) Patent Application Publication
(10) Pub. No.: US 2026/0008963 A1
(43) Pub. Date: Jan. 8, 2026

(54) HYDROTHERMALLY STABLE AND NON-REACTIVE ADSORBENT FOR CRACKED GAS DEHYDRATION

(71) Applicant: UOP LLC, Des Plaines, IL (US)

(72) Inventors: Shyamli, Haryana (IN); Satish Kumar, Haryana (IN); Gautam Pandey, Haryana (IN); Benjamin Curtiss Siegert, Mobile, AL (US); Jayant K. Gorawara, Buffalo Grove, IL (US); Rodrigo J. Lobo, Des Plaines, IL (US); Christopher J. Garrett, Mobile, AL (US); Aleksei Vjunov, Des Plaines, IL (US)

(21) Appl. No.: 19/088,170

(22) Filed: Mar. 24, 2025

(30) Foreign Application Priority Data
Jul. 8, 2024 (IN) 202411052224

(51) Int. Cl. C10G 25/05; B01J 20/18; B01J 20/28; B01J 20/30

(52) U.S. Cl. CPC C10G 25/05; B01J 20/186; B01J 20/2803; B01J 20/28073; B01J 20/2808; B01J 20/3007; B01J 20/3014; B01J 20/3064; B01J 20/3078; B01J 20/3085

(57) ABSTRACT

Adsorbents which are more hydrothermally stable, less reactive, and have longer life are described. The adsorbent comprises 60 wt % to 95 wt % zeolite, wherein the zeolite is an LTA zeolite in hydrogen, ammonium, potassium, calcium or sodium form, wherein the zeolite has a ratio of silica/alumina in a range of 1 and 1.5; 5 wt % to 30 wt % binder; 0.1 to 5 wt % phosphorous in the form of phosphoric acid, or a phosphate salt, or a pyrophosphate salt, or combinations thereof; and 0.5 to 10 wt % silica. Processes of preparing the adsorbent, and methods of drying or purifying a liquid hydrocarbon, a gas hydrocarbon, a renewable feedstocks, carbon dioxide, or combinations thereof, using the adsorbent are also described.

### CROSS-REFERENCES TO RELATED APPLICATIONS

This application claims the benefit of Indian Patent Application Number 202411052224 filed on Jul. 8, 2024, the entire disclosure of which is incorporated herein by way of reference.

### BACKGROUND

A major application for KA zeolite, an LTA zeolite, adsorbents is cracked gas dehydration. Customers desire a product with a longer life than is available with some existing KA zeolite adsorbents. The parameters that contribute to shorter life for an adsorbent include hydrothermal aging, high reactivity, the impact of caustic carryover, which result increased pressure drop, green oil formation, decrease in mechanical integrity, and premature water breakthrough.

Therefore, there is a need for a KA zeolite, an LTA zeolite adsorbent which is more hydrothermally stable, and less reactive with olefinic stream/hydrocarbon, which will result in longer adsorbent life.

### DESCRIPTION

The present invention involves a novel adsorbent having high hydrothermal stability and low break-up. As a result, it enables a higher temperature regeneration cycle, and lower regeneration utilities and operational expenses. The adsorbent also has very low reactivity with the cracked gas stream.

The novel synthesis technique allows pore size engineering. The pore size is controlled by the combined effect of silica deposition and alkali and/or alkaline metal ion exchange. Alkali and/or alkaline metal silicate treatment masks the surface reactivity arising from the binder as well as the zeolite surface defects. The adsorbent has higher water adsorption capacity as compared to standard commercially available KA zeolite adsorbents. For example, the potassium exchange is expected to be about 15%; as a result, the adsorbent is expected to show similar water adsorption capacity as that of NaA zeolite adsorbents. The present adsorbent also has better hydrothermal stability compared to the standard commercially available KA zeolite type adsorbents. The present adsorbent exhibits less than 1 wt % breakup. Consequently, regeneration can be carried out at a higher temperature. In addition, the adsorbent demonstrates lower reactivity. The present adsorbent shows much lower coke formation in acetylene reactivity testing in the pilot plant than standard commercially available KA zeolite adsorbent Furthermore, the adsorbent is resistant to caustic carryover.

The KA zeolite type molecular sieves of the current invention are prepared by pore engineering of NaA zeolite molecular sieves using 1 to 40 wt % aqueous solution of alkali metal silicates. The temperature treatment, concentration of the silicates, and calcination duration can depend on the extent of the silica deposition required.

One aspect of the invention is an adsorbent. In one embodiment, the adsorbent comprises 60 wt % to 95 wt % zeolite, wherein the zeolite is an LTA zeolite in hydrogen, ammonium, potassium, calcium or sodium form, wherein the zeolite has a ratio of silica/alumina in a range of 1 and 1.5; 5 wt % to 30 wt % binder; 0.1 to 5 wt % phosphorous in the form of phosphoric acid, or a phosphate salt, or a pyrophosphate salt, or combinations thereof; and 0.5 to 10 wt % silica.

In some embodiments, the framework cations in the zeolite are replaced with alkali and alkaline metal ions to tailor zeolite pores. In some embodiments, the sodium ions in the framework are replaced with potassium ions.

In some embodiments, the potassium ions are present in a range of 1-10 mass %, or 1-5 mass % after replacement.

In some embodiments, sodium ions are present in a range of 3-19 mass %, or 8-15 mass % after replacement.

In some embodiments, the zeolite is a LTA zeolite.

In some embodiments, the adsorbent has a pore size in a range of 2.8 to 3.8 Angstroms, or 2.8 to 3.3, or 2.8 to 3. In some embodiments, the adsorbent has a total pore volume of 0.2 to 0.5 cm³/g. Pore size and total pore volume are measured using BET and mercury porosimeter.

In some embodiments, the median pore diameter is 0.00025 micrometer or greater. In some embodiments, the median pore diameter is in the range of 0.00025 micrometer to 1.5 micrometer. In some embodiments, the median pore diameter is 1.8 micrometers or less.

In some embodiments, the adsorbent has a ratio of silica salt to LTA zeolite (NaA) cake in the range of 0.01 to 0.25, or 0.01 to 0.13.

In some embodiments, the adsorbent exhibits a water adsorption capacity of 17-29 wt. % at 4-18 mm Hg and a temperature of 22° C. In some embodiments, the adsorbent exhibits a CO2 adsorption capacity of 0.5 to 10.0 wt. % at 250 torr and temperature of 22° C. In some embodiments, the adsorbent exhibits a coking tendency of less than 1.0 wt. % carbon when exposed to a nitrogen gas stream containing 2-5% by volume of acetylene at a temperature less than or equal to 100° C. and a time period of less than or equal to 24 hrs;. In some embodiments, the adsorbent exhibits less than 1.0 wt. % break-up, or less than 0.5 wt %, when exposed to free-flowing water at the rate of greater than or equal to 25 ml/min for greater than or equal to 5 minutes and regenerated at 220-350° C. for greater than or equal to 30 minutes. In some embodiments, the adsorbent exhibits one or more of these characteristics.

In some embodiments, the phosphorous is present in the form of a sodium or potassium phosphate salt, or a sodium or potassium pyrophosphate salt.

In some embodiments, the silica is selected from amorphous silica, crystalline silica, alkali-metal containing silicates, or combinations thereof. Suitable alkali-metal containing silicates include, but are not limited to, sodium or potassium silicate.

In some embodiments, the binder comprises alumina, silica, aluminosilicate, bentonite, attapulgite, halloysite, kaolinite, cement, zirconia, or mixtures thereof.

In some embodiments, the binder has a particle size in a range of 0.01 and 1 mm, or 0.05 to 0.5 mm.

Another aspect of the invention is a process for preparing an adsorbent, In one embodiment, the process comprises mixing an LTA type zeolite, a binder, a pore directing agent, a dispersing agent, and a porosity generating agent to form a mixture; added an aqueous solution of alkali metal silicate, or alkaline metal silicate, or both to replace a portion of Na ion in NaA with K ions; mulling and kneading the mixture; extruding the mulled and kneaded mixture to form shaped bodies; and drying and calcining the shaped bodies.

In some embodiments, the shaped bodies are dried at 80-120° C.; or the dried shaped bodies are calcined at 400 to 900° C., or 600 to 750° C.; or both.

In some embodiments, the pore generating agent can be any suitable burnout agent. Suitable burnout agents include, but are not limited to, a combustible material in an amount of 0 to 10 wt %, or 0 to 9 wt %, or 0 to 8 wt %, or 0 to 7 wt %, or 0 to 6 wt %, or 0 to 5 wt %, or 0 to 4 wt %, or 0 to 3 wt %.

In some embodiments, the adsorbent has 3-19 mass % Na ions, or 8-15 mass %. In some embodiments, the adsorbent has 1-10 mass % K ions, or 1-5 mass %. In some embodiments, the adsorbent has 8-15 mass % Na ions, and 1-10 mass % K ions.

In some embodiments, the dried formed bodies were calcined under a controlled atmosphere comprising nitrogen, air, water steam, CO₂, a reducing atmosphere, or combinations thereof.

Another aspect of the invention is a method of drying or purifying a liquid hydrocarbon, a gas hydrocarbon, a renewable feedstock, carbon dioxide, or combinations thereof. In one embodiments, the method comprises contacting the liquid hydrocarbon, the gas hydrocarbon, the renewable feedstock, the carbon dioxide, or combinations thereof with an adsorbent comprising 60 wt % to 95 wt % zeolite, wherein the zeolite is an LTA zeolite in hydrogen, ammonium, potassium, calcium or sodium form, wherein the zeolite has a ratio of Si/Al in a range of 1 and 1.5, 5 wt % to 30 wt % binder, 0.1 to 5 wt % phosphorous in the form of phosphoric acid, or a phosphate salt, or a pyrophosphate salt, or combinations thereof; and 0.5 to 10 wt % silica.

In some embodiments, the liquid hydrocarbon, the gas hydrocarbon, the renewable feedstock, the carbon dioxide, or combinations thereof is dried, and the liquid hydrocarbon, the gas hydrocarbon, the renewable feedstock, the carbon dioxide, or combinations thereof comprises ethylene cracked gas, ethylene cracked gas liquid, natural gas, natural gas liquid, refinery off gas, refinery off gas liquid, the renewable feedstocks, or the carbon dioxide, or combinations thereof.

Suitable renewable feed stocks include, but are not limited to, like bio-oils, biodiesel, alcohols, and the like.

In some embodiments, the liquid or gas hydrocarbon is purified and the purification comprises removing methanol from propylene, removing methanol from natural gas, removing ammonia from cracked gas, or combinations thereof.

### EXAMPLES

### Example 1

70 g of zeolite A powder was mixed with 19.0 g of clay binder, 0.1 g of phosphate salt, 4.0 g of carboxy methyl cellulose, and 0.1 g of combustible material on dry basis followed by addition of 7.0 g of aqueous solution of active amorphous silica (targeting the silicate/NaA zeolite cake ratio of 0.1). The mixture was mulled for 45 minutes, followed by extrusion to the size of 1/16″ (both in cylindrical and trilobes shapes) through an extruder. The extrudates were then dried at 80° C. in a box oven and calcined at 600° C. The adsorption capacity of the prepared adsorbent for water and carbon dioxide along with coke formation were measured, and the data are given in Table 1.

### Example 2

85 g of zeolite A powder was mixed with 5.0 g of clay binder, and 4.0 g of phosphate/pyrophosphate salt on dry basis followed by addition of 6.0 g of aqueous solution of active amorphous silica (targeting the silicate/NaA zeolite cake ratio of 0.07). The mixture was mulled for 45 minutes followed by extrusion to the size of ⅛″ (both in cylindrical and trilobes shapes) through an extruder. The extrudates were then dried at 110° C. in a box oven and calcined at 650° C. The adsorption capacity of this prepared adsorbent for water and carbon dioxide along with coke formation were measured, and the data are given in Table 1.

### Example 3

60 g of zeolite A powder was mixed with 30.0 g of clay binder, 0.9 g of phosphate/pyrophosphate, 0.1 g of carboxy methyl cellulose, and 1.0 g of combustible material on dry basis followed by addition of 8.0 g of aqueous solution of active amorphous silica (targeting the silicate/NaA zeolite cake ratio of 0.13). The mixture was mulled for 45 minutes followed by extrusion in the size of ¼″ (both in cylindrical and trilobes shapes) through an extruder. The extrudates were then dried at 110° C. in a box oven and calcined at 500° C., in the presence of sparge air and no steam. The adsorption capacity of this prepared adsorbent for water and carbon dioxide along with coke formation were measured, and the data are given in Table 1.

### Example 4

65 g of zeolite A powder was mixed with 25.0 g of clay binder, 5.0 g of

phosphate/pyrophosphate, 1.0 g of Carboxy methyl cellulose, and 3.0 g of combustible material on dry basis followed by addition of 1.0 g of aqueous solution of active amorphous silica (targeting the silicate/NaA zeolite cake ratio of 0.02). The mixture was mulled for 45 minutes followed by extrusion to the size of ⅛″ (both in cylindrical and trilobes shapes) through an extruder. The extrudates were then dried at 120° C. in a box oven and calcined at 700 and C, in the presence of partial sparge air and steam. The adsorption capacity of this prepared adsorbent for water and carbon dioxide along with coke formation were measured, and the data are given in Table 1.

### Example 5

76 g of zeolite A powder was mixed with 12.0 g of clay binder, 0.6 g of phosphate/pyrophosphate, 3.6 g of carboxy methyl cellulose, and 1.0 g of combustible material on dry basis followed by addition of 6.8 g aqueous solution of active amorphous silica (targeting the silicate/NaA zeolite cake ratio of 0.02). The mixture was mulled for 45 minutes followed by extrusion to the size of ⅛″ (both in cylindrical and trilobes shapes) through an extruder. The extrudates were then dried at 120° C. in a box oven and calcined at 620° C. in the presence of sparge air and steam. The adsorption capacity of this prepared adsorbent for water and carbon dioxide along with coke formation and the data are given in Table 1.

### Example 6

50 g of zeolite A powder was mixed with 38.0 g of clay binder, 0.9 g of phosphate/pyrophosphate, 0.1 g of carboxy methyl cellulose, and 1.0 g of combustible material on dry basis followed by addition of 10.0 g of aqueous solution of potassium silicate (targeting the silicate/NaA zeolite cake ratio of 0.13). The mixture was mulled for 45 minutes followed by extrusion in the size of ¼″ (both in cylindrical and trilobes shapes) through an extruder. The extrudates were then dried at 110° C. in a box oven and calcined at 550° C. in the presence of sparge air and no steam. The adsorption capacity of this prepared adsorbent for water and carbon dioxide along with coke formation and the data are given in Table 1.

### Example 7

87 g of zeolite A powder was mixed with 3.0 g of halloysite clay, and 4.0 g of phosphate/pyrophosphate on dry basis followed by addition of 6.0 g of aqueous solution of potassium silicate (targeting the silicate/NaA zeolite cake ratio of 0.07). The mixture was mulled for 45 minutes followed by extrusion to the size of ⅛″ (both in cylindrical and trilobes shapes) through an extruder. The extrudates were then dried at 110° C. in a box oven and calcined at 650° C., The adsorption capacity of this prepared adsorbent for water and carbon dioxide along with coke formation and the data are given in Table 1.

### Example 8

The adsorbent bodies prepared in Examples 1-5 were tested for acetylene reactivity (coke formation). The adsorbent bodies were loaded in adsorber, and 6% acetylene was passed through the bed at T=90-100° C., P=11-13 bar and flow rate of 10-15 ml/min for 10-16 hours. The absorbent was unloaded and checked for the carbon (coke) formation over the absorbent (reported in Table 1).

The adsorbent bodies were also tested for hydrothermal stability. The adsorbent bodies were loaded in a reactor and exposed to free-flowing water at the rate of 30-40 ml/min at least for 5-10 minutes, and the absorbent was regenerated at 220-250° C. for at least 30-40 minutes. The exposed adsorbent bodies were unloaded, and the percentage thermal stability was measured (reported in Table 1).

TABLE 1

| | | H₂O | CO₂ | | |
|---|---|---|---|---|---|
| | Calcination | (wt %) | (wt %) | Hydrothermal | Coke |
| | Temp | At 17.6 | At 250 | stability | Build-up |
| Example | (° C.) | torr | torr | (wt %) | (wt %) |
| 1 | 600 | 23.2 | 9.2 | 90 | 0.2 |
| 2 | 650 | 21.1 | 1.1 | 98 | 0.1 |
| 3 | 500 | 23.1 | 4.5 | 98 | 0.2 |
| 4 | 700 | 22.5 | 8.5 | 90 | 0.2 |
| 5 | 620 | 21.0 | 2.5 | 98 | 0.1 |
| 6 | 550 | 21.5 | 3.7 | 98 | 0.08 |
| 7 | 650 | 19.6 | 1.2 | 97 | 0.09 |

The results reveal that all of the formulations are hydrothermally stable and are much less reactive with olefinic species, especially the most reactive species, acetylene. The adsorbents are regenerable at high temperature.

### Specific Embodiments

While the following is described in conjunction with specific embodiments, it will be understood that this description is intended to illustrate and not limit the scope of the preceding description and the appended claims.

A first embodiment of the invention is a composition comprising 60 wt % to 95 wt % zeolite, wherein the zeolite is an LTA zeolite in hydrogen, ammonium, potassium, calcium or sodium form, wherein the zeolite has a ratio of silica/alumina in a range of 1 and 1.5; 5 wt % to 30 wt % binder; 0.1 to 5 wt % phosphorous in the form of phosphoric acid, or a phosphate salt, or a pyrophosphate salt, or combinations thereof; and 0.5 to 10 wt % silica. An embodiment of the invention is one, any or all of prior embodiments in this paragraph up through the first embodiment in this paragraph wherein framework cations in the zeolite are replaced with alkali and alkaline metal ions to tailor zeolite pores. An embodiment of the invention is one, any or all of prior embodiments in this paragraph up through the first embodiment in this paragraph wherein the framework cations are sodium ions and the sodium ions are replaced with potassium ions. An embodiment of the invention is one, any or all of prior embodiments in this paragraph up through the first embodiment in this paragraph wherein the potassium ions are present in a range of 1-10 mass %. An embodiment of the invention is one, any or all of prior embodiments in this paragraph up through the first embodiment in this paragraph wherein sodium ions are present in a range of 3-19 mass %. An embodiment of the invention is one, any or all of prior embodiments in this paragraph up through the first embodiment in this paragraph wherein the zeolite is an LTA zeolite. An embodiment of the invention is one, any or all of prior embodiments in this paragraph up through the first embodiment in this paragraph wherein the adsorbent has a pore size in a range of 2.8 to 3.8 Angstroms. An embodiment of the invention is one, any or all of prior embodiments in this paragraph up through the first embodiment in this paragraph wherein the adsorbent has a total pore volume of 0.2 to 0.5 cm³/g, or a median pore diameter greater than or equal to 0.00028 micrometer or greater, or both. An embodiment of the invention is one, any or all of prior embodiments in this paragraph up through the first embodiment in this paragraph wherein the adsorbent has a ratio of silica salt to zeolite A cake in a range of 0.01 to 0.25. An embodiment of the invention is one, any or all of prior embodiments in this paragraph up through the first embodiment in this paragraph wherein the adsorbent exhibits a water adsorption capacity of 17-29 wt. % at 4-18 mm Hg and a temperature of 22° C.; or a CO2 adsorption capacity of 0.5 to 10.0 wt. % at 250 torr and temperature of 22° C.; or a coking tendency of less than 1.5 wt. % carbon when exposed to a nitrogen gas stream containing 2-5% by volume of acetylene at a temperature less than or equal to 100° C. and a time period of less than or equal to 24 hrs; or less than 1.0 wt. % break-up, when exposed to free-flowing water at the rate of greater than or equal to 25 ml/min for greater than or equal to 5 minutes and regenerated at 220-350° C. for greater than or equal to 30 minutes; or combinations thereof. An embodiment of the invention is one, any or all of prior embodiments in this paragraph up through the first embodiment in this paragraph wherein the phosphorous is present in the form of a sodium or potassium phosphate salt or a sodium or potassium pyrophosphate salt. An embodiment of the invention is one, any or all of prior embodiments in this paragraph up through the first embodiment in this paragraph wherein the silica is selected from amorphous silica, crystalline silica, alkali-metal containing silicates, or combinations thereof. An embodiment of the invention is one, any or all of prior embodiments in this paragraph up through the first embodiment in this paragraph wherein the binder comprises alumina, silica, aluminosilicate, bentonite, attapulgite, halloysite, kaolinite, cement, zirconia, or mixtures thereof. An embodiment of the invention is one, any or all of prior embodiments in this paragraph up through the first embodiment in this paragraph wherein the binder has a particle size in a range of 0.01 and 1 mm.

A second embodiment of the invention is a process for preparing an adsorbent comprising mixing an LTA zeolite, a binder, a pore directing agent, a dispersing agent, and a porosity generating agent to form a mixture; adding an aqueous solution of alkali metal silicate, or alkaline metal silicate, or both to replace a portion of an extra framework cation in the LTA zeolite with the alkali metal or alkaline metal ions from the alkali metal silicate or alkaline metal silicate; mulling and kneading the mixture; extruding the mulled and kneaded mixture to form shaped bodies; and drying and calcining the shaped bodies. An embodiment of the invention is one, any or all of prior embodiments in this paragraph up through the second embodiment in this paragraph wherein the shaped bodies are dried at 80-120° C., or wherein the dried shaped bodies are calcined at 400 to 900° C., or both. An embodiment of the invention is one, any or all of prior embodiments in this paragraph up through the second embodiment in this paragraph, wherein the pore generating agent is a combustible material in an amount of 0 to 3 wt %. An embodiment of the invention is one, any or all of prior embodiments in this paragraph up through the second embodiment in this paragraph wherein the adsorbent has 8-15 mass % Na ions and 1-10 mass % K ions. An embodiment of the invention is one, any or all of prior embodiments in this paragraph up through the second embodiment in this paragraph, wherein the dried formed bodies were calcined under a controlled atmosphere comprising nitrogen, air, water steam, CO₂, a reducing atmosphere, or combination thereof.

A third embodiment of the invention is a process of drying or purifying a liquid hydrocarbon, a gas hydrocarbon, a renewable feedstocks, carbon dioxide, or combinations thereof, comprising contacting the liquid hydrocarbon, the gas hydrocarbon, the renewable feedstock, the carbon dioxide, or combinations thereof with an adsorbent comprising 60 wt % to 95 wt % zeolite, wherein the zeolite is an LTA zeolite in hydrogen, ammonium, potassium, calcium or sodium form, wherein the zeolite has a ratio of Si/Al in a range of 1 and 1.5; 5 wt % to 30 wt % binder; 0.1 to 5 wt % phosphorous in the form of phosphoric acid, or a phosphate salt, or a pyrophosphate salt, or combinations thereof; and 0.5 to 10 wt % silica.

Without further elaboration, it is believed that using the preceding description that one skilled in the art can utilize the present invention to its fullest extent and easily ascertain the essential characteristics of this invention, without departing from the spirit and scope thereof, to make various changes and modifications of the invention and to adapt it to various usages and conditions. The preceding preferred specific embodiments are, therefore, to be construed as merely illustrative, and not limiting the remainder of the disclosure in any way whatsoever, and that it is intended to cover various modifications and equivalent arrangements included within the scope of the appended claims.

In the foregoing, all temperatures are set forth in degrees Celsius and, all parts and percentages are by weight, unless otherwise indicated.

We claim:

1. An adsorbent comprising:
60 wt % to 95 wt % zeolite, wherein the zeolite is an LTA zeolite in hydrogen, ammonium, potassium, calcium or sodium form, wherein the zeolite has a ratio of silica/alumina in a range of 1 and 1.5;
5 wt % to 30 wt % binder;
0.1 to 5 wt % phosphorous in the form of phosphoric acid, or a phosphate salt, or a pyrophosphate salt, or combinations thereof; and
0.5 to 10 wt % silica.

2. The adsorbent of claim 1 wherein framework cations in the zeolite are replaced with alkali and alkaline metal ions to tailor zeolite pores.

3. The adsorbent of claim 2 wherein the framework cations are sodium ions and the sodium ions are replaced with potassium ions.

4. The adsorbent of claim 3 wherein the potassium ions are present in a range of 1-10 mass %.

5. The adsorbent of claim 1 wherein sodium ions are present in a range of 3-19 mass %.

6. The adsorbent of claim 1 wherein the zeolite is an LTA zeolite.

7. The adsorbent of claim 1 wherein the adsorbent has a pore size in a range of 2.8 to 3.8 Angstroms.

8. The adsorbent of claim 1 wherein the adsorbent has a total pore volume of 0.2 to 0.5 cm³/g, or a median pore diameter greater than or equal to 0.00028 micrometer, or both.

9. The adsorbent of claim 1 wherein the adsorbent has a ratio of silica salt to zeolite A cake in a range of 0.01 to 0.25.

10. The adsorbent of claim 1 wherein the adsorbent exhibits:
a water adsorption capacity of 17-29 wt. % at 4-18 mm Hg and a temperature of 22° C.; or
a CO₂ adsorption capacity of 0.5 to 10.0 wt. % at 250 torr and temperature of 22° C.; or
a coking tendency of less than 1.5 wt. % carbon when exposed to a nitrogen gas stream containing 2-5% by volume of acetylene at a temperature less than or equal to 100° C. and a time period of less than or equal to 24 hrs; or
less than 1.0 wt. % break-up, when exposed to free-flowing water at the rate of greater than or equal to 25 ml/min for greater than or equal to 5 minutes and regenerated at 220-350° C. for greater than or equal to 30 minutes; or
combinations thereof. 10

11. The adsorbent of claim 1 wherein the phosphorous is present in the form of a sodium or potassium phosphate salt or a sodium or potassium pyrophosphate salt.

12. The adsorbent of claim 1 wherein the silica is selected from amorphous silica, crystalline silica, alkali-metal containing silicates, or combinations thereof.

13. The adsorbent of claim 1 wherein the binder comprises alumina, silica, aluminosilicate, bentonite, attapulgite, halloysite, kaolinite, cement, zirconia, or mixtures thereof.

14. The adsorbent of claim 1 wherein the binder has a particle size in a range of 0.01 and 1 mm.

15. A process for preparing an adsorbent comprising:
mixing an LTA zeolite, a binder, a pore directing agent, a dispersing agent, and a porosity generating agent to form a mixture;
adding an aqueous solution of alkali metal silicate, or alkaline metal silicate, or both to replace a portion of an extra framework cation in the LTA zeolite with the alkali metal or alkaline metal ions from the alkali metal silicate or alkaline metal silicate;
mulling and kneading the mixture;
extruding the mulled and kneaded mixture to form shaped bodies; and
drying and calcining the shaped bodies.

16. The process of claim 15 wherein the shaped bodies are dried at 80-120° C., or wherein the dried shaped bodies are calcined at 400 to 900° C., or both.

17. The process of claim 15, wherein the pore generating agent is a combustible material in an amount of 0 to 3 wt %.

18. The process of claim 15 wherein the adsorbent has 8-15 mass % Na ions and 1-10 mass % K ions.

19. The process of claim 15, wherein the dried formed bodies were calcined under a controlled atmosphere comprising nitrogen, air, water steam, CO₂, a reducing atmosphere, or combination thereof.

20. A process of drying or purifying a liquid hydrocarbon, a gas hydrocarbon, a renewable feedstocks, carbon dioxide, or combinations thereof, comprising:
contacting the liquid hydrocarbon, the gas hydrocarbon, the renewable feedstock, the carbon dioxide, or combinations thereof with an adsorbent comprising:
60 wt % to 95 wt % zeolite, wherein the zeolite is an LTA zeolite in hydrogen, ammonium, potassium, calcium or sodium form, wherein the zeolite has a ratio of Si/Al in a range of 1 and 1.5;
5 wt % to 30 wt % binder;
0.1 to 5 wt % phosphorous in the form of phosphoric acid, or a phosphate salt, or a pyrophosphate salt, or combinations thereof; and
0.5 to 10 wt % silica.
